(19) United States
(12) Patent Application Publication
(10) Pub. No.: US 2021/0392004 A1
(43) Pub. Date: Dec. 16, 2021

(54) APPARATUS AND METHOD FOR AUTHENTICATING DEVICE BASED ON CERTIFICATE USING PHYSICAL UNCLONABLE FUNCTION

(71) Applicant: ELECTRONICS AND TELECOMMUNICATIONS RESEARCH INSTITUTE, Daejeon (KR)

(72) Inventors: Byoung-Koo KIM, Daejeon (KR); Seung-Yong YOON, Daejeon (KR); You-Sung KANG, Daejeon (KR); Doo-Ho CHOI, Cheonan-si (KR); Ik-Kyun KIM, Daejeon (KR); Tae-Sung KIM, Daejeon (KR); Mi-Kyung OH, Daejeon (KR); Sang-Jae LEE, Daejeon (KR)

(73) Assignee: ELECTRONICS AND TELECOMMUNICATIONS RESEARCH INSTITUTE, Daejeon (KR)

(21) Appl. No.: 17/208,212

(22) Filed: Mar. 22, 2021

(30) Foreign Application Priority Data
Jun. 10, 2020 (KR) 10-2020-0070436

(51) Int. Cl. H04L 9/32; H04L 9/08

(52) U.S. Cl. CPC H04L 9/3278; H04L 9/3268; H04L 9/0825

(57) ABSTRACT

Disclosed herein are an apparatus and method for device authentication. The method for device authentication based on a certificate using a PUF, performed by an apparatus for device authentication based on a certificate using a PUF, includes acquiring previously stored first Challenge-Response-Pair (CRP) information corresponding to identification information received from a device that requests authentication and generating a certificate including a public key generated using the first CRP information; transmitting a message in which the certificate encrypted using the first response value of the first CRP information as a server secret key and the first challenge value of the first CRP information are included to the device; and authenticating the device by verifying an encrypted signature message received from the device through a secure channel.

### CROSS REFERENCE TO RELATED APPLICATION

This application claims the benefit of Korean Patent Application No. 10-2020-0070436, filed Jun. 10, 2020, which is hereby incorporated by reference in its entirety into this application.

### BACKGROUND OF THE INVENTION

### 1. Technical Field

The present invention relates generally to IoT technology, and more particularly to technology for authenticating a device based on a certificate using a Physical Unclonable Function (PUF) in an IoT environment.

### 2. Description of the Related Art

Currently, most IoT devices have software-based security applied thereto, but despite the application of various forms of software-based security, a lot of cases of damage resulting from various types of hacking are reported. Furthermore, because most IoT devices are lightweight and low-power systems, lightweight security systems, rather than heavy software-based security, are commonly applied thereto. Also, because a key is stored in memory due to the characteristics of software-based security, it is likely that exposure of the key will result in large amounts of damage. Recently, thanks to the rapid development of IT technology, state-of-the-art devices have emerged, but economic and industrial losses incurred from forgery using illegal replication are continually increasing.

In order to solve the above-mentioned problems, a Physical Unclonable Function (PUF) has emerged. A PUF is technology for imparting a unique characteristic to respective devices, similar to biometric information, such as a fingerprint, an iris, or the like of a human, and enables devices to have different characteristics even though the devices are produced through the same manufacturing process. That is, even though devices are produced using the same method, the unique characteristic of each device cannot be cloned. Accordingly, when a non-replicable PUF is implemented using any of various methods, a key can be generated through the PUF whenever the key is required, without the need to store the key, whereby reliable security against the threat of key exposure may be improved. The key generated using PUF technology may be effectively used in order to encrypt data that can be leaked or to authenticate an IoT device.

When the above-described PUF technology is used for authentication, a unique identifier for identifying each device may be generated inside the device without a process of inputting the same from the outside. Also, because it is not necessary to allocate internal nonvolatile memory for storing each identifier, a cost reduction can be expected. The PUF technology is configured such that circuits produced through the same manufacturing process have different output values when provided with the same input value. Therefore, a pair comprising the input and output of each PUF circuit may be used as a Challenge-Response Pair (CRP) for authenticating each device. That is, pieces of CRP information for authenticating devices are stored in advance in the database of an authentication server, and a CRP generated through the PUF module of the device to be authenticated is compared therewith, whereby the device may be authenticated. FIG. 1 is a view illustrating the process of authenticating a device using such a PUF.

As shown in FIG. 1, an authentication server manages pieces of CRP information for each device by storing the same in a CRP database, and transmits a challenge value which is randomly selected from among n pieces of CRP information, to a specific device A in response to an authentication request therefrom. Whenever a request is made, the device generates a response value for the received challenge value using the PUF module thereof and replies with the response value, and the authentication server checks whether the response value matches a response value for the corresponding challenge value, which is stored in the server, thereby authenticating the device. Here, CRP information that has been used once is deleted in order to prevent sniffing, replay attacks, and the like. However, this authentication method based on a PUF requires the authentication server to store and manage a large amount of CRP information for each device registered therein, and the amount increases in proportion to the number of devices registered in the authentication server. Also, various security threats can be generated when CRP information of the authentication server, which is stored in a storage medium, is exposed through various paths. Accordingly, required is an effective authentication method that is robust to the exposure of an authentication key while reducing the load imposed on the authentication server due to management of CRP information used as authentication keys.

In order to respond to such a requirement, various forms of improved methods have been proposed, but most of these methods still use a method of authenticating a device by directly matching CRP information. That is, an efficient device authentication method capable of minimizing security threats resulting from the direct exposure of CRP information and facilitating authentication key management in an authentication server while still providing the above-described technique of device authentication based on a PUF is required.

Meanwhile, Korean Patent No. 10-2094606, titled “Authentication apparatus and method”, discloses an authentication apparatus and method in which a response signal is generated by inputting a challenge signal generated using a device identification value of a device requesting authentication to a PUF circuit, after which authentication is performed using ciphertext generated using the response signal and the challenge signal.

### SUMMARY OF THE INVENTION

An object of the present invention is to provide a more secure and efficient device authentication method by fundamentally preventing a private key, which is used for generating and distributing a certificate based on a public key and authenticating a device, from being exposed.

Another object of the present invention is to prevent the threat of an attack on a certificate for a digital signature, to effectively respond to exposure of an authentication key, and to contribute to securement of interoperability and security and technology extension in an IoT market based on compatibility and interworking with existing technology.

In order to accomplish the above objects, a method for device authentication based on a certificate using a Physical Unclonable Function (PUF), performed by an apparatus for device authentication based on a certificate using a PUF, according to an embodiment the present invention includes acquiring previously stored first Challenge-Response-Pair (CRP) information corresponding to identification information received from a device that requests authentication and generating a certificate including a public key generated using the first CRP information; transmitting a message in which the certificate encrypted using the first response value of the first CRP information as a server secret key and the first challenge value of the first CRP information are included to the device; and verifying an encrypted signature message received from the device through a secure channel, thereby authenticating the device.

Here, generating the certificate may be configured to generate the public key using the first response value as a private key and to generate the certificate including the identification information and the public key.

Here, the method may further include generating, by the device, a second response value from the first challenge value using a PUF and decrypting, by the device, the certificate using the second response value as a device secret key.

Here, decrypting the certificate may be configured such that the device compares the identification information included in the decrypted certificate with the previously stored identification and thereby verifies validity of the certificate.

Here, authenticating the device may be configured to communicate with the device through the secure channel, connected based on a preset security protocol.

Here, the encrypted signature message may be acquired in such a way that the device encrypts a signature message on the secure channel using the second response value as a private key.

Here, authenticating the device may be configured to decrypt the encrypted signature message using the public key included in the certificate and to authenticate the device by verifying the decrypted signature message.

Here, the method may further include receiving second CRP information from the device through the secure channel and updating the first CRP information to the second CRP information.

Here, updating the first CRP information may be configured such that, when the device is successfully authenticated, the device generates the second CRP information by selecting an update challenge value and generating an update response value from the update challenge value using the PUF.

Here, updating the first CRP information may be configured to receive the second CRP information from the device through the secure channel, to update the first CRP information to the second CRP information, and to reply with information about whether the update is completed to the device.

Also, in order to accomplish the above objects, an apparatus for device authentication based on a certificate using a Physical Unclonable Function (PUF) according to an embodiment of the present invention includes one or more processors and executable memory for storing at least one program executed by the one or more processors. The at least one program may be configured to acquire previously stored first Challenge-Response-Pair (CRP) information corresponding to identification information received from a device that requests authentication and generate a certificate including a public key generated using the first CRP information; to transmit a message in which the certificate encrypted using the first response value of the first CRP information as a server secret key and the first challenge value of the first CRP information are included to the device; and to verify an encrypted signature message received from the device through a secure channel and thereby authenticate the device.

Here, the at least one program may generate the public key using the first response value as a private key and generate the certificate including the identification information and the public key.

Here, the device may generate a second response value from the first challenge value using a PUF and decrypt the certificate using the second response value as a device secret key.

Here, the device may compare the identification information included in the decrypted certificate with the previously stored identification information and thereby verify validity of the certificate.

Here, the at least one program may communicate with the device through the secure channel connected based on a preset security protocol.

Here, the encrypted signature message may be acquired in such a way that the device encrypts a signature message on the secure channel using the second response value as a private key.

Here, the at least one program may decrypt the encrypted signature message using the public key included in the certificate and authenticate the device by verifying the decrypted signature message.

Here, the at least one program may receive second CRP information from the device through the secure channel and update the first CRP information to the second CRP information.

Here, when the device is successfully authenticated, the device may generate the second CRP information by generating an update response value from a previously stored update challenge value using the PUF.

Here, the at least one program may receive the second CRP information from the device through the secure channel, update the first CRP information to the second CRP information, and reply with information about whether the update is completed to the device.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a view illustrating a method for authenticating a device using a PUF;

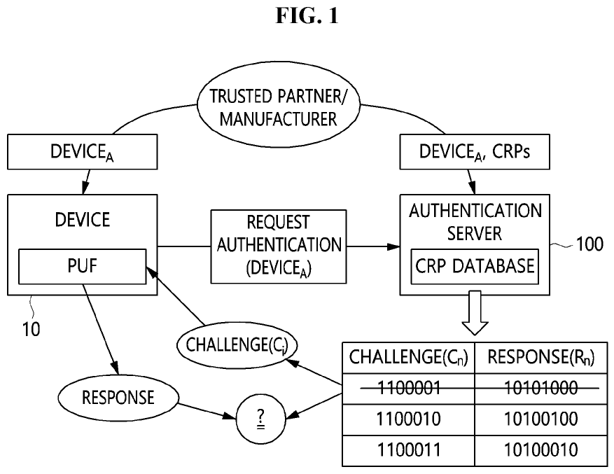

FIG. 2 is a view illustrating a system for authenticating a device based on a certificate using a PUF according to an embodiment of the present invention;

FIG. 3 is a sequence diagram illustrating a method for authenticating a device based on a certificate using a PUF according to an embodiment of the present invention;

FIG. 4 is a sequence diagram illustrating an example of the TLS-based authentication step illustrated in FIG. 3 in detail; and

FIG. 5 is a view illustrating a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

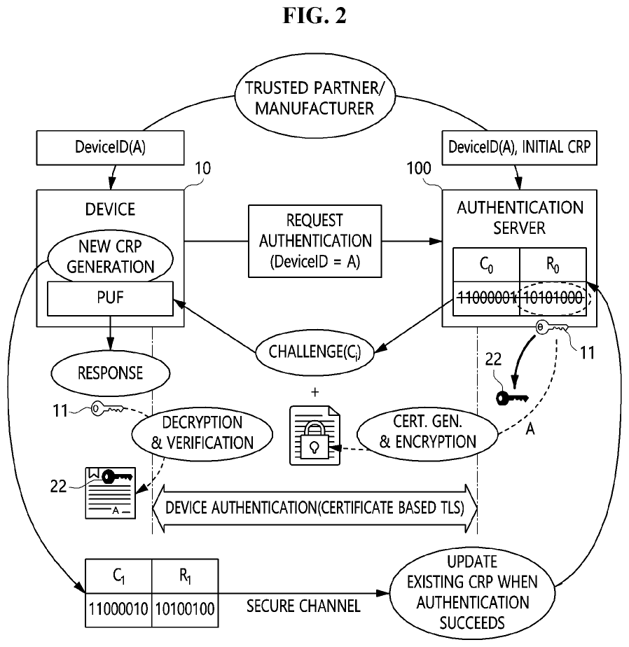

FIG. 2 is a view illustrating a system for authenticating a device based on a certificate using a PUF according to an embodiment of the present invention.

Referring to FIG. 2, the system for authenticating a device based on a certificate using a PUF according to an embodiment of the present invention may include a device 10 that makes a request for device authentication based on a certificate using a PUF and an authentication server 100, which is an apparatus for device authentication based on a certificate using a PUF.

The system for authenticating a device based on a certificate using a PUF according to an embodiment of the present invention may provide a device authentication technique that appropriately uses a CRP value, which is a pair comprising the input and output of a Physical Unclonable Function (PUF), in order to generate a certificate of a device and verify a digital signature.

Also, the PUF fundamentally prevents a private key, which is used for device authentication based on a certificate, from being exposed, thereby minimizing the possibility of a security threat attributable to the exposure of an authentication key.

Accordingly, the system for authenticating a device based on a certificate using a PUF according to an embodiment of the present invention provides an IoT device authentication method based on a certificate and uses PUF technology to generate and distribute the certificate and verify a digital signature, thereby providing more secure and efficient device authentication.

First, the authentication server 100 may start operation using a single piece of initial CRP information generated from the PUF operation unit of the device 10 to authenticate (such initial settings must be performed in a manufacturing process or in a secure environment). In the initial settings, the device 10 may store the identification information of device A (that is, the device, the device ID of which is A) in advance. In this case, the device 10 may be the device A.

Here, the device 10 transmits a message including the identification information, which indicates the device, the device ID of which is A, to the authentication server 100, thereby requesting authentication.

Here, the authentication server 100 may generate the certificate to transmit to the device 10 based on the basic information (the initially set ID information and the like) of device A and a predefined public-key generation method (public-key cryptography such as RSA or ECC) (a certificate generation process through an external Certification Authority (CA) server or the like may be omitted).

Here, in response to the authentication request, the authentication server 100 may acquire the initial CRP information corresponding to the device, the device ID of which is A, from a database in which the initial CRP information has been stored in advance.

Here, the authentication server 100 may generate a public key 22 using an initial response value Ro, corresponding to the initial challenge value Co of the initial CRP information of the device 10, as a private key 11.

Here, the authentication server 100 may generate a certificate, including the public key 22 and the identification information indicating the device 10, the device ID of which is A.

Here, the authentication server 100 may transmit a message, including the certificate and the initial challenge value Co, to the device 10.

Here, the certificate may be encrypted using preset symmetric-key cryptography (symmetric-key cryptography such as DES or AES) in order to prevent the certificate from being exposed to the outside, and as a symmetric key therefor, the initial response value Ro, corresponding to the initial challenge value Co of the corresponding device, may be reused.

Also, the device 10 may generate a response value using the initial challenge value Co included in the received message as the input of the PUF, and may decrypt the received certificate using the generated response value as the secret key 11.

Here, the device 10 checks whether the identification information included in the decrypted certificate is the same as the identification information thereof, thereby verifying whether the certificate is valid.

Here, when the certificate is valid, the device 10 may communicate with the authentication server 100 through a secure channel based on a preset security protocol method.

Here, as the security protocol method, Transport Layer Security (TLS) communication, which is used for certificate-based communication, may be used.

Here, the authentication server 100 may authenticate the device 10 by verifying the certificate received from the device 10 through the secure channel.

Here, when authentication of the device 10 succeeds, the device 10 may generate new arbitrary updated CRP information (C₁, R₁) to use for subsequent authentication, and may transmit the updated CRP information to the authentication server 100 through the secure channel generated through TLS communication.

Finally, the authentication server 100 may update the existing initial CRP information to the received updated CRP information, reply with the result of the update as acknowledgement (ACK), and manage the updated CRP information.

As described above, the system for authenticating a device based on a certificate using a PUF according to an embodiment of the present invention uses a CRP value, which is a pair comprising the input and output of a PUF module, in order to generate a certificate using public-key cryptography and to verify a digital signature, thereby providing a more effective and secure device authentication method and minimizing a security threat attributable to exposure of a private key used for device authentication based on a public key.

Also, the device authentication method of the system for authenticating a device based on a certificate using a PUF according to an embodiment of the present invention may also be applied to an authentication method that uses public-key cryptography but does not use a certificate.

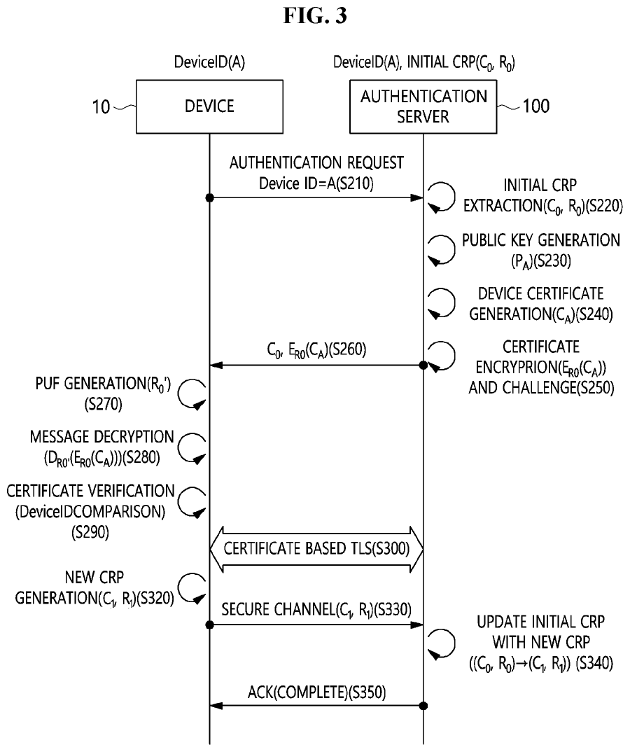

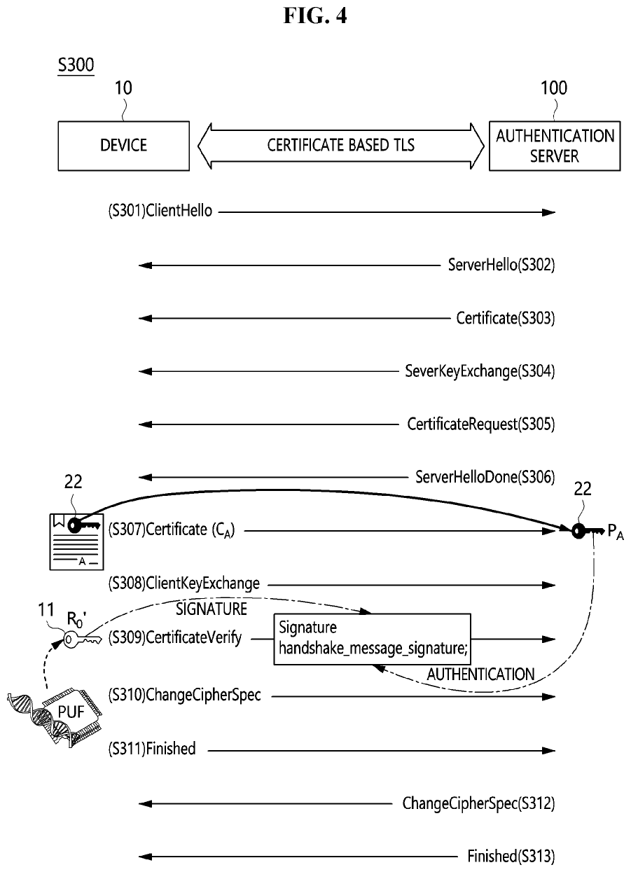

FIG. 3 is a sequence diagram illustrating a method for authenticating a device based on a certificate using a PUF according to an embodiment of the present invention. FIG. 4 is a sequence diagram illustrating an example of the TLS-based authentication step illustrated in FIG. 3 in detail.

Referring to FIG. 3, a method for authenticating a device based on a certificate using a PUF according to an embodiment of the present invention may be configured such that the respective steps thereof are performed by a device 10 that sends a request for authentication and an authentication server 100 that performs device authentication by receiving the request for authentication.

Here, the device 10 may store its identification information indicating the device 10, the device ID of which is A, and the authentication server 100 may store initial CRP information corresponding to identification information of devices in the internal database thereof.

First, the device 10 may request authentication at step S210 by transmitting an authentication request message including its identification information indicating the device 10, the device ID of which is A, to the authentication server 100.

The authentication server 100 may acquire previously stored first Challenge-Response-Pair (CRP) information corresponding to the identification information received from the device 10 requesting authentication at step S220.

That is, at step S220, the authentication server 100 may acquire the previously stored initial CRP information (C_{O}, R_{O}), corresponding to the identification information, in which the device ID is A, from the internal database.

The authentication server 100 may generate a public key P_{A} based on predefined public-key cryptography, such as RSA, ECC, or the like, using the first response value R_{O} of the initial CRP information (C_{O}, R_{O}) as a private key at step S230.

The authentication server 100 may generate a certificate C_{A} including the identification information and the public key P_{A} at step S240.

The authentication server 100 may encrypt the certificate based on predefined symmetric-key cryptography, such as DES, AES, or the like, using the first response value Ro of the first CRP information (C_{O}, R_{O}) as a server secret key at step S250.

The authentication server 100 may transmit a message, including the encrypted certificate E_{RO}(C_{A}) and the first challenge value C_{O} of the first CRP information (C_{O}, R_{O}), to the device 10 at step S260.

The device 10 may generate a second response value R_{O′} from the first challenge value C_{O} included in the message using a Physical Unclonable Function (PUF) at step S270.

The device 10 may decrypt the encrypted certificate E_{RO}(C_{A}) using the second response value R_{O′} as a device secret key (D_{RO′}(E_{RO}(C_{A}))=C_{A}) at step S280.

The device 10 compares the identification information included in the decrypted certificate C_{A} with the previously stored identification information, thereby verifying whether the certificate C_{A} is valid at step S290.

That is, at step S290, the device 10 checks whether the device ID included in the decrypted certificate C_{A} is A, thereby verifying the validity of the certificate C_{A}.

The authentication server 100 may perform device authentication using a secure channel through which connection with the device 10 is established based on Transport Layer Security (TLS) communication, which is a preset security protocol, at step S300.

That is, at step S300, TLS communication, which is used for communication based on a certificate, may be performed when the result of verification of the validity of the certificate CA performed by the device 10 is that the certificate is determined to be valid.

Referring to FIG. 4, it can be seen that the device 10 operates as the client of TLS communication and that the authentication server 100 operates as the server of TLS communication.

First, the device 10 may transmit a “ClientHello” message to the authentication server 100 through TLS communication at step S301.

Here, the “ClientHello” message may include information, such as a TLS version available in the client, a session identifier, cipher settings, and the like.

The authentication server 100 may reply with a “ServerHello” message to the device 10 through TLS communication at step S302.

Here, the “ServerHello” message may include information such as a TLS version available in the server, a session identifier, cipher settings, and the like.

The authentication server 100 may transmit a “Certificate” message including the security certificate of the server to the device 10 at step S303.

The authentication server 100 may transmit a “ServerKeyExchange” message to the device 10 at step S304 when the certificate is used only for a signature.

The authentication server 100 may transmit a “CertificateRequest” message for requesting the certificate of the device to the device 10 at step S305.

The authentication server 100 may transmit a “ServerHelloDone” message, which indicates that all of the messages that have to be sent are transmitted, to the device 10 at step S306.

The device 10 may transmit the certificate C_{A} to the authentication server 100 at step S307.

Here, at step S307, the device 10 may transmit a “Certificate” message including the certificate CA to the authentication server 100.

Here, the certificate may include the public key 22, which is generated using the first response value of the initial CRP information as a private key.

The device 10 may transmit a “ClientKeyExchange” message to the authentication server 100 at step S308 when the certificate is used only for a signature.

The device 10 may encrypt a signature message for handshake messages using the second response value R_{O′} as a private key 11, and may transmit the encrypted signature message to the authentication server 100 at step S309.

Here, at step S309, the authentication server 100 may decrypt the signature message using the public key 22 included in the certificate C_{A} received from the device 10, and may authenticate the device 10 by verifying the decrypted signature message.

The device 10 may transmit a “ChangeCipherSpec” message to the authentication server 100 at step S310.

The device 10 may transmit a “Finished” message for completing transmission of the encrypted signature message to the authentication server 100 at step S311.

The authentication server 100 may transmit a “ChangeCipherSpec” message to the device 10 at step S312.

The authentication server 100 may transmit a “Finished” message, which indicates that the device is successfully authenticated based on the decrypted signature message, to the device 10 at step S313.

Referring again to FIG. 3, the device 10 may confirm that authentication thereof succeeds, select a previously stored arbitrary update challenge value C₁, generate an update response value R₁ from the update challenge value C₁ using the PUF, and generate second CRP information (C₁, R₁) including the update challenge value C₁ and the update response value R₁ at step S320.

The authentication server 100 may receive the second CRP information (C₁, R₁) from the device 10 through the secure channel generated by performing TLS communication at step S330.

The authentication server 100 may update the first CRP information (C_{O}, R_{O}) to the second CRP information (C₁, R₁), which is received from the device 10, at step S340.

The authentication server 100 may reply with information about whether update is completed (ACK(COMPLETE)) to the device 10 at step S350.

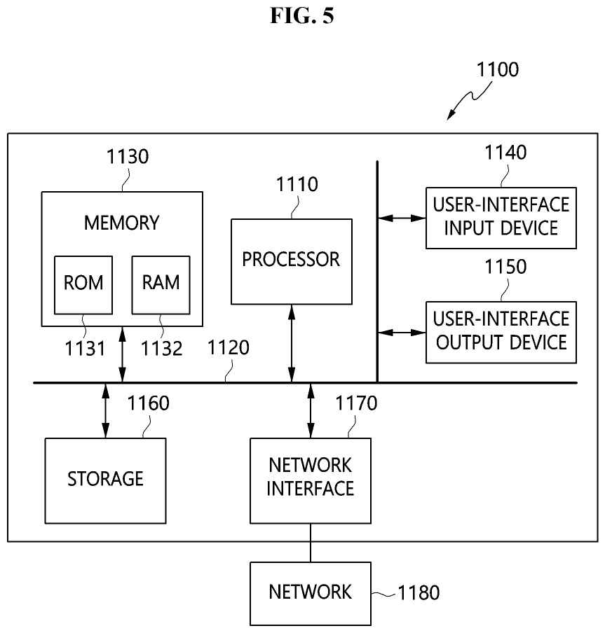

FIG. 5 is a view illustrating a computer system according to an embodiment of the present invention.

Referring to FIG. 5, the device and the authentication server for authentication based on a certificate using a PUF according to an embodiment of the present invention may be implemented in a computer system 1100 including a computer-readable recording medium. As illustrated in FIG. 5, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

An authentication server 100, which is an apparatus for authenticating a device based on a certificate using a PUF according to an embodiment of the present invention, includes one or more processors 1110 and executable memory 1130 for storing at least one program executed by the one or more processors 1110. The at least one program may acquire previously stored first Challenge-Response-Pair (CRP) information corresponding to identification information received from a device 10 that requests authentication, generate a certificate including a public key generated using the first CRP information, transmit a message in which the certificate encrypted using the first response value of the first CRP information as a server secret key and the first challenge value of the first CRP information are included to the device 10, and verify an encrypted signature message received from the device 10 through a secure channel, thereby performing authentication of the device.

Here, the at least one program may generate the public key using the first response value as a private key, and may generate the certificate including the identification information and the public key.

Here, the device 10 may generate a second response value from the first challenge value using a Physical Unclonable Function (PUF), and may decrypt the certificate using the second response value as a device secret key.

Here, the device 10 may verify the validity of the certificate by comparing the identification information included in the decrypted certificate with the previously stored identification information.

Here, the at least one program may communicate with the device 10 through the secure channel, connected based on a preset security protocol.

Here, the encrypted signature message may be acquired in such a way that the device 10 encrypts a signature message on the secure channel using the second response value as a private key.

Here, the at least one program may decrypt the encrypted signature message using the public key included in the certificate, and may authenticate the device by verifying the decrypted signature message.

Here, the at least one program may receive second CRP information from the device 10 through the secure channel, and may update the first CRP information to the second CRP information.

Here, when authentication of the device 10 succeeds, the device 10 may generate the second CRP information by generating an update response value from a previously stored update challenge value using the PUF.

Here, the at least one program may receive the second CRP information from the device 10 through the secure channel, update the first CRP information to the second CRP information, and reply with information about whether the update is completed to the device 10.

The present invention may provide a more secure and efficient method for authenticating a device by fundamentally preventing a private key, which is used for generating and distributing a certificate based on a public key and authenticating the device, from being exposed.

Also, the present invention may prevent the threat of an attack on a certificate for a digital signature, may effectively respond to exposure of an authentication key, and may contribute to securement of interoperability and security and technology extension in an IoT market based on compatibility and interworking with existing technology.

As described above, the apparatus and method for authenticating a device based on a certificate using a PUF according to the present invention are not limitedly applied to the configurations and operations of the above-described embodiments, but all or some of the embodiments may be selectively combined and configured, so the embodiments may be modified in various ways.

What is claimed is:

1. A method for device authentication based on a certificate using a Physical Unclonable Function (PUF), performed by an apparatus for device authentication based on a certificate using a PUF, the method comprising:
acquiring previously stored first Challenge-Response-Pair (CRP) information corresponding to identification information received from a device that requests authentication and generating a certificate including a public key generated using the first CRP information;
transmitting a message in which the certificate encrypted using a first response value of the first CRP information as a server secret key and a first challenge value of the first CRP information are included to the device; and
verifying an encrypted signature message received from the device through a secure channel, thereby authenticating the device.

2. The method of claim 1, wherein generating the certificate is configured to generate the public key using the first response value as a private key and to generate the certificate including the identification information and the public key.

3. The method of claim 2, further comprising:
generating, by the device, a second response value from the first challenge value using a PUF, and
decrypting, by the device, the certificate using the second response value as a device secret key.

4. The method of claim 3, wherein decrypting the certificate is configured such that the device compares the identification information included in the decrypted certificate with the previously stored identification and thereby verifies validity of the certificate.

5. The method of claim 3, wherein authenticating the device is configured to communicate with the device through the secure channel, connected based on a preset security protocol.

6. The method of claim 5, wherein the encrypted signature message is acquired in such a way that the device encrypts a signature message on the secure channel using the second response value as a private key.

7. The method of claim 6, wherein authenticating the device is configured to decrypt the encrypted signature message using the public key included in the certificate and to authenticate the device by verifying the decrypted signature message.

8. The method of claim 7, further comprising:
receiving second CRP information from the device through the secure channel and updating the first CRP information to the second CRP information.

9. The method of claim 8, wherein updating the first CRP information is configured such that, when the device is successfully authenticated, the device generates the second CRP information by selecting an update challenge value and generating an update response value from the update challenge value using the PUF.

10. The method of claim 9, wherein updating the first CRP information is configured to receive the second CRP information from the device through the secure channel, to update the first CRP information to the second CRP information, and to reply with information about whether the update is completed to the device.

11. An apparatus for device authentication based on a certificate using a Physical Unclonable Function (PUF), comprising:
one or more processors; and
executable memory for storing at least one program executed by the one or more processors,
wherein the at least one program is configured to:
acquire previously stored first Challenge-Response-Pair (CRP) information corresponding to identification information received from a device that requests authentication and generate a certificate including a public key generated using the first CRP information;
transmit a message in which the certificate encrypted using a first response value of the first CRP information as a server secret key and a first challenge value of the first CRP information are included to the device; and
verify an encrypted signature message received from the device through a secure channel and thereby authenticate the device.

12. The apparatus of claim 11, wherein the at least one program generates the public key using the first response value as a private key and generates the certificate including the identification information and the public key.

13. The apparatus of claim 12, wherein the device generates a second response value from the first challenge value using a PUF and decrypts the certificate using the second response value as a device secret key.

14. The apparatus of claim 13, wherein the device compares the identification information included in the decrypted certificate with the previously stored identification information and thereby verifies validity of the certificate.

15. The apparatus of claim 13, wherein the at least one program communicates with the device through the secure channel connected based on a preset security protocol.

16. The apparatus of claim 15, wherein the encrypted signature message is acquired in such a way that the device encrypts a signature message on the secure channel using the second response value as a private key.

17. The apparatus of claim 16, wherein the at least one program decrypts the encrypted signature message using the public key included in the certificate and authenticates the device by verifying the decrypted signature message.

18. The apparatus of claim 17, wherein the at least one program receives second CRP information from the device through the secure channel and updates the first CRP information to the second CRP information.

19. The apparatus of claim 18, wherein, when the device is successfully authenticated, the device generates the second CRP information by generating an update response value from a previously stored update challenge value using the PUF.

20. The apparatus of claim 19, wherein the at least one program receives the second CRP information from the device through the secure channel, updates the first CRP information to the second CRP information, and replies with information about whether the update is completed to the device.
